(19) United States
(12) Patent Application Publication
(10) Pub. No.: US 2009/0312075 A1
(43) Pub. Date: Dec. 17, 2009

(54) METHOD AND APPARATUS FOR DETERMINING OPEN OR CLOSED STATUS OF A MOBILE DEVICE

(75) Inventor: Jacob Warren Kimbrell, Raleigh, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB

(21) Appl. No.: 12/138,858

(22) Filed: Jun. 13, 2008

(51) Int. Cl. H04M 1/02

(52) U.S. Cl. 455/575.3

(57) ABSTRACT

Determination of a closed or open status of a mobile communication device, having a cover that may be in hinged or in slidable engagement with the device body housing, is made by sensing an input from the device microphone. The cover and housing form an acoustical seal when the device is closed. In accordance with the sensed input of the microphone the device controller can detect whether the cover is in a closed or open state with respect to the housing. An off-hook telephone status can then be set when the open state is detected on the basis of the microphone input and the telephone display activated.

### FIELD OF THE INVENTION

The present invention relates to mobile communication devices, more particularly to determining open and closed states of such devices.

### BACKGROUND

Mobile communication devices, such as cellular phones and the like, have become increasingly prevalent. These devices provide the convenience of a handheld communication device that is capable of increased functionality. An expanding variety of additional features have become available, for example, short or multimedia messaging, multimedia playback, electronic mail, audio-video capturing, interactive gaming, data manipulation, web browsing, and the like. Other enhancements, such as, location-awareness features, e.g., global position system (GPS) tracking, enable mobile communication devices to monitor their position and present their location via a local display.

Convenience and ease of use continue to be objectives for improvement. The focus of the structural design of mobile phones continues to stress compactness of size, incorporating powerful processing functionality within smaller and slimmer phones. To further these objectives, various devices have been developed and gained popularity, such as the flip phone, clam shell, slider, jack knife. Components of these devices are distributed within a housing of the phone body and a cover, which are movably coupled to each other. The cover may be in hinged or in slidable engagement with the housing.

Structure of a typical flip, or clam, phone is illustrated in perspective view in FIG. 1. The phone body 10 includes various keypad elements 12, microphone 14, and magnet 16, which are located at a surface of the body housing. Additional user control elements, not shown, may be provided at side surfaces of the housing. Within the housing are contained a controller and associated communication hardware. The phone body 10 is structurally coupled via hinge 18 to the cover 20. At the illustrated surface of cover 20 are speaker 22 and display 24. The cover may also include other elements that are not shown, such as an antenna and another display located on an opposite surface.

In the closed configuration, the cover protects the keypad elements when the phone is not in use. The phone may be powered off or powered down in an on-hook status. For example, the phone may terminate a call when the cover is set to the closed position and the phone is thereafter configured to receive incoming calls. When closed, other features may be available. For example, the display on the opposite surface of the cover may be active to present widget applications or other information. In the open configuration, the keypad is uncovered and the phone attains an off-hook status. The user then has a variety of keypad features available in addition to dial-out capability. If the phone is left open, an activity timer will time out and the phone goes into a low power mode.

The phone is equipped with the ability to determine whether the cover is in an open or closed state with respect to the telephone housing. When the phone is closed, a magnetic sensor, which may be located in either the housing or the cover, will sense a strong magnetic field. The phone controller recognizes the magnetic sensor output as indication of the closed state and administer the features for this status. When open, the cover is displaced from the housing. The magnetic field is then of insufficient strength for detection by the sensor. The controller, which then lacks the higher level input from the magnetic sensor, will activate the features attendant the open status.

The magnet and magnetic sensor are elements used solely for determining the open or closed status of the device. If this determination were to be performed instead by elements within the device that are also used to implement the communication functions, the structural real estate occupied by the magnet and magnetic sensor elements can be eliminated or used by other required elements. Accordingly, a need exists for an improved technique for determining cover status.

### DISCLOSURE

The above described needs are fulfilled, at least in part, by sensing an input from the mobile telephone microphone and, in response, determining the positional state of the mobile telephone cover in relation to the body of the device. The telephone cover and housing form an acoustical seal when the device is closed. Thus, in accordance with the sensed input from the microphone the controller can detect whether the cover is in a closed or open state with respect to the housing of the telephone. An off-hook telephone status can then be set when the open state is detected on the basis of the microphone input and the telephone display activated. The telephone cover and housing form an acoustical seal when the device is closed. Thus, in accordance with the sensed input from the microphone the controller can detect whether the cover is in a closed or open state with respect to the housing of the telephone. An off-hook telephone status can then be set when the open state is detected on the basis of the microphone input and the telephone display activated. The cover and/or the housing may contain a display. An on-hook telephone status can be set when the closed state is detected on the basis of the microphone input. The microphone and the controller that receives the microphone input are essential elements of the device that are used in normal communication.

The acoustical seal may be implemented, for example, in a “flip” phone in which a cover member is attached via a hinge to a housing member. In the closed position, both members are engaged as a substantially planar surface of the cover member mates with a corresponding surface of the housing member, the two surfaces being in substantial contact with each other. The surface of the housing member contains a spatial indentation. At or near the bottom of the surface indentation, the telephone microphone is situated. At the surface of the cover member a protrusion is formed. The protrusion is configured to mate with the indentation in the housing member when the cover is closed. In this position both the surface of the cover member and the surface of the housing member are aligned in relative contact with each other. The protrusion portion of the cover member ensures that there is effectively an acoustic seal with the microphone that blocks sensing by the microphone of outside noise.

The microphone can be activated at predetermined time intervals during which time input data from the microphone is sampled. The sampled input data can be compared with a stored data profile that is indicative of microphone input data when the cover is closed or, alternatively, open. For example, the decibel level represented by the sampled data may be compared with a threshold decibel level. The sampled data can be transferred to a number representing an average and then compared with a previously calibrated microphone level. Alternatively, a waveform of the sampled data can be derived and compared with a waveform indicative of the closed state or open state. The sampling rate of the microphone input data for purposes of determining cover position status may be different from the sampling rate of microphone input data during communication operation of the mobile telephone in its off-hook status.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawing and in which like reference numerals refer to similar elements and in which:

FIG. 1 is a perspective illustration of a typical flip phone structure.

FIG. 2 is a perspective illustration of phone structure in accordance with the invention, exemplified in the context of a flip phone.

FIG. 3 is an enlarged perspective illustration of elements shown in FIG. 2.

FIG. 4 is a high level functional block diagram of a mobile station such as shown in FIG. 2.

FIG. 5 is a high level flowchart of operation of the mobile station such of FIG. 2.

FIG. 6 is a more detailed flowchart for operation in an exemplified embodiment.

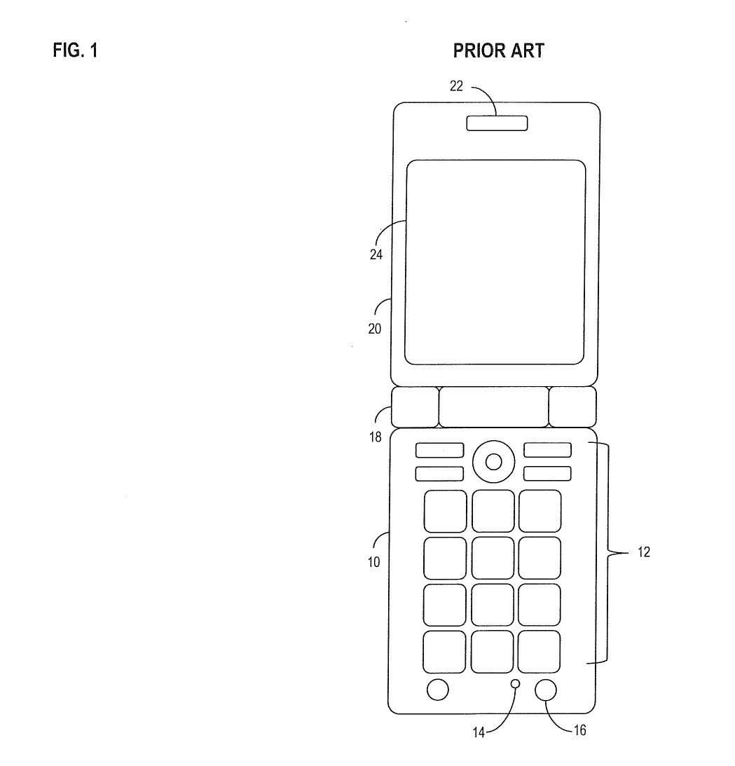

### DETAILED DESCRIPTION

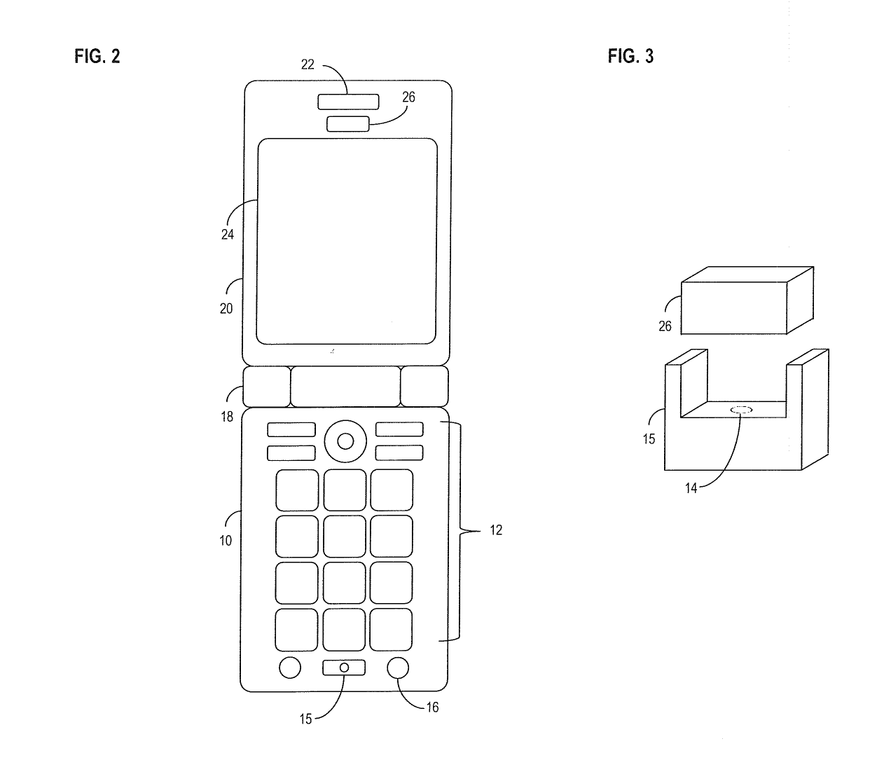

FIGS. 2 and 3 illustrate an exemplified embodiment of the present disclosure. As shown in FIG. 2, a protrusion 26 is formed on the surface of the cover 20. Microphone 14 is located in an indentation 15 in the surface of the body housing 10. When the cover is flipped to the closed position, the raised surface of the protrusion 26 will fit into the indented area 15 to seal the area around microphone 14. An exemplified configuration of protrusion 26, indentation 15 and microphone 14 is represented in FIG. 3. It should be understood that the dimensions and geometric characteristics of these elements may be adjusted to provide an appropriate seal for the microphone.

Acoustic properties in the microphone environment are different when the microphone 14 is sealed in the closed position of the cover 20 than when the microphone 14 is exposed in the open position of cover 20. It is thus possible to detect whether the clam is open or shut on the basis of noise characteristics read by the microphone 14. The input from microphone 14 can be applied to a polling algorithm to check noise characteristics.

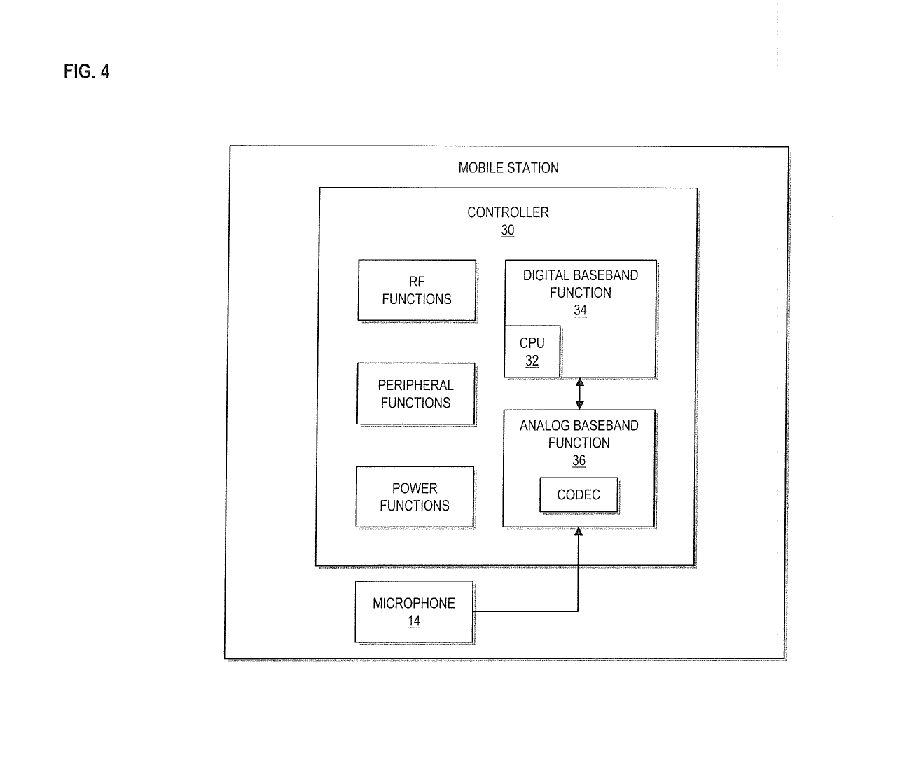

FIG. 4 is a high level functional block diagram of the mobile station. Controller 30 includes a central processing unit 32 that executes a microphone polling algorithm via digital baseband function block 34 and analog baseband function block 36. Other mobile station functions that are not involved with the algorithm are shown generally as RF functions, peripheral functions, and power functions. Digital baseband block 34 initiates and executes the microphone algorithm. The analog baseband block 36 includes CODEC functionality. The CODEC will capture the microphone data and relay the data to the digital baseband block 36. The digital baseband block 36 may utilize a multitude of techniques to process the data.

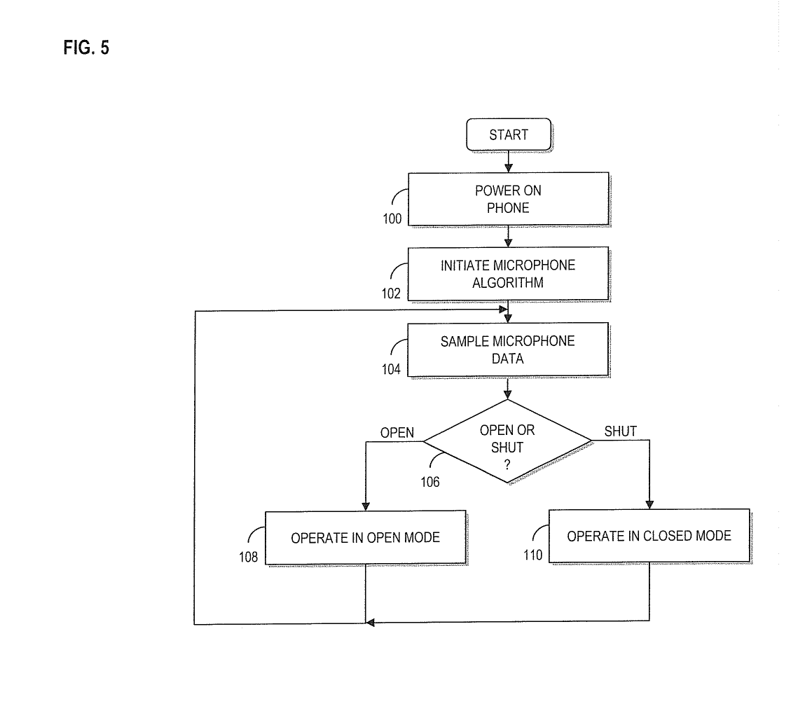

FIG. 5 is a high level flowchart exemplifying the mobile station operation while determining the open or closed status. At step 100, the phone is powered on. The microphone algorithm begins at step 102. At step 104, the microphone data are sampled. Determination is made at step 106 whether the sensed microphone data indicates that the cover is open or shut. If an open status has been determined in step 106, then the controller will operate in accordance with the open mode at step 108. During this time, the process reverts to step 104 to continually sample the microphone input. If a shut status has been determined in step 106, then the controller will operate in accordance with the closed mode at step 110. During this time, the process reverts to step 104 to continually sample the microphone input.

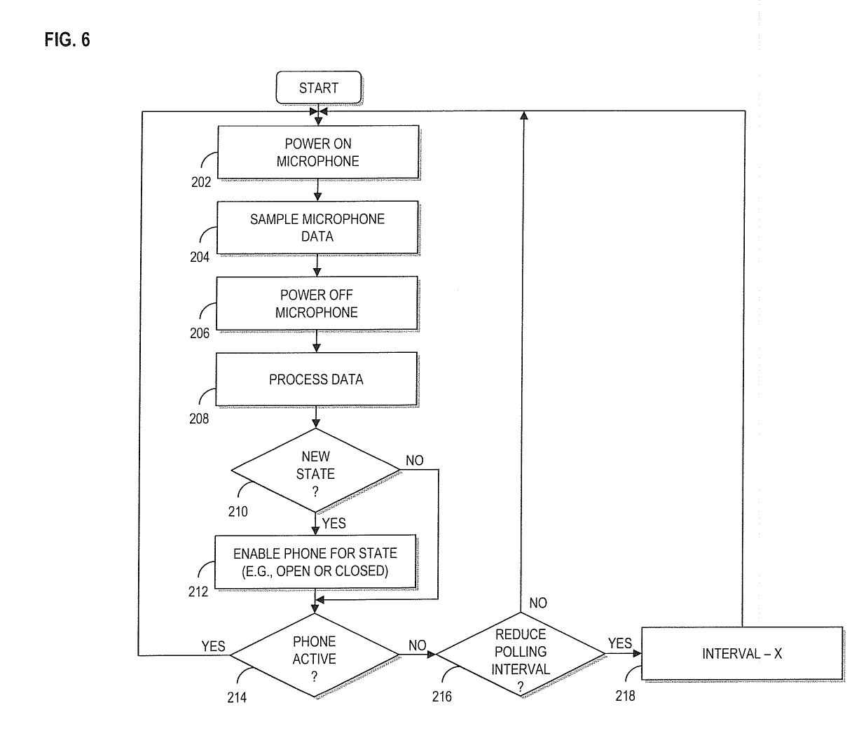

FIG. 6 is a more detailed flowchart for operation in an exemplified embodiment. The microphone may be turned on periodically for predetermined length of time for sampling of data. For example, the microphone may be turned on every 250 ms. At step 202 the microphone is turned on. An audio processing application is initiated and the analog microphone data is sampled at step 204 for a time interval. At the conclusion of the time interval, the microphone is turned off at step 206. The sampled data are processed at step 208 by the audio processing application, which may compare the sampled data to a stored profile for closed (or, alternatively, open) position.

The sampled data can be transferred to a number representing an average and then compared with a previously calibrated microphone level. There can be a stored waveform of what the closed cover would represent for comparison with a waveform of the sampled microphone data to judge delta. A series of comparisons may be implemented, for example, an amplitude comparison followed by a comparison to a known fourier signal.

At step 210, determination is made as to whether the state determined at step 208 is a new state, by comparison with the outcome of the previously sampled data. If so, the controller will enable the phone for operation in the mode of the sensed state at step 212. After this enablement, or if no new state has been determined at step 210, the outcome of the decision block at step 214 will indicate whether the phone is in an active state. If so, the process reverts to step 202 and the sampling interval will remain at the same level.

In one variation of this process, an option may be set to decrease the sampling interval if the phone is not in an active state. If the outcome of step 214 indicates that the phone is not active, it is determined at step 216 whether the polling interval is to be reduced. If not, the process reverts to step 202 and the sampling interval will remain at the same level. If it is determined at step 216 that the polling interval is to be reduced, the controller will adjust the algorithm to diminish the interval by a predetermined amount (X). The process then reverts to step 202 for continued sampling at the reduced interval.

In this disclosure there are shown and described only preferred embodiments of the invention and but a few examples of its versatility. It is to be understood that the invention is capable of use in various other combinations and environments and is capable of changes or modifications within the scope of the inventive concept as expressed herein. For example, in lieu of forming a complete acoustic seal, the surrounding body of the microphone may be modified to provide an acceptable muffled effect in the closed cover position.

What is claimed is:

1. A method for operating a mobile telephone, the method comprising:
sensing an input from the mobile telephone microphone; and
in response to the sensed input, determining a positional status of the mobile telephone.

2. A method as recited in claim 1, wherein a characteristic of the microphone input corresponds to a positional state of a cover member of the telephone, and the step of sensing comprises detecting whether the cover member is in a closed or open state with respect to a housing member of the telephone.

3. A method as recited in claim 2, wherein the step of determining comprises setting an on-hook telephone status in accordance with detection of the closed state, and setting an off-hook telephone status in accordance with detection of the open state.

4. A method as recited in claim 2, further comprising activating a display in accordance with detection of the open state.

5. A method as recited in claim 2, wherein:
the step of sensing further comprises setting the microphone to an active state at predetermined time intervals;
the step of detecting comprises sampling input data from the microphone in its active state; and
the step of detecting comprises comparing the sampled input data with a stored data profile.

6. A method as recited in claim 5, wherein the stored data profile comprises a decibel threshold.

7. A method as recited in claim 5, wherein the step of detecting further comprises translating the sampled data to a number representing an average, and the step of detecting comprises comparing the number with stored data representing a previously calibrated microphone level.

8. A method as recited in claim 5, wherein the step of detecting further comprises deriving a waveform of the sampled data, and the step of detecting comprises comparing the derived waveform with a waveform indicative of the closed state.

9. A method as recited in claim 5, wherein the step of detecting comprises sampling microphone input data at a rate different from the sampling rate of microphone input data during communication operation of the mobile telephone in the off-hook status.

10. A method as recited in claim 2, wherein the cover member and the housing are acoustically sealed in the closed state.

11. A mobile apparatus comprising:
a housing member having a substantially planar surface;
a cover member having a substantially planar surface, the cover member attached to the housing member and moveable to open and closed positions with respect to the housing member, the surfaces of the housing member and cover member being in contact with each other in the closed position and separated from each other in the open position; wherein
the housing member comprises a spatial indentation in its planar surface and a microphone positioned within the indentation; and
the cover member comprises a protrusion at its surface that mates with the indented portion of the housing in the closed position.

12. A mobile apparatus as recited in claim 11, wherein the microphone is acoustically sealed with the cover member in the closed state.

13. A mobile apparatus as recited in claim 12, wherein the housing member further comprises:
a controller coupled to an input from the microphone;
wherein the controller is configured to sense microphone input data having a first characteristic when the cover member is in a closed position and a second characteristic when the cover member is in an open condition.

14. A mobile apparatus as recited in claim 13, wherein the controller is configured to set an on-hook telephone status in response to receipt of data input having the first characteristic and to set an off-hook telephone status in response to receipt data input having the second characteristic.

15. A mobile apparatus as recited in claim 13, further comprising a display screen coupled to the controller, and the controller is configured to activate the display screen in response to receipt of data input having the second characteristic.

16. A mobile apparatus as recited in claim 15, wherein the display screen is embodied in the cover member.

17. A mobile apparatus as recited in claim 15, wherein the display screen is embodied in the housing member.
